(19) United States
(12) Patent Application Publication
(10) Pub. No.: US 2026/0187048 A1
(43) Pub. Date: Jul. 2, 2026

(54) FILTER, FILTERING METHOD, DATA PROCESSING SYSTEM, AND CHIP

(71) Applicant: SHENZHEN MICROBT ELECTRONICS TECHNOLOGY CO., LTD., SHENZHEN, GUANGDONG (CN)

(72) Inventors: Yingnan LV, SHENZHEN, GUANGDONG (CN); Zhijun FAN, SHENZHEN, GUANGDONG (CN); Xiaoqiao CHEN, SHENZHEN, GUANGDONG (CN); Zuoxing YANG, SHENZHEN, GUANGDONG (CN)

(73) Assignee: SHENZHEN MICROBT ELECTRONICS TECHNOLOGY CO., LTD., SHENZHEN, GUANGDONG (CN)

(21) Appl. No.: 18/844,733

(22) PCT Filed: Jun. 24, 2024
(86) PCT No.: PCT/CN2024/100871

§ 371 Date: Sep. 6, 2024

(30) Foreign Application Priority Data
Sep. 7, 2023 (CN) 202311150821.9

(51) Int. Cl. G06F 16/22

(52) U.S. Cl. CPC G06F 16/2264

(57) ABSTRACT

The present disclosure relates to a filter, a filtering method, a data processing system, and a chip. A filter for performing N-dimensional Gaussian filtering on an N-dimensional data set, where N is 2 or 3, the filter including: a calculation factor obtaining module configured to obtain N calculation factors for N dimensions, where the N calculation factors correspond to N one-dimensional Gaussian kernels derived from performing N-dimensional vector decomposition on an N-dimensional Gaussian kernel to be used for the N-dimensional data set; and a calculation module including N calculation sub-modules for N dimensions that are arranged in a cascading manner, where each calculation sub-module is configured to perform, in a respective dimension using a respective calculation factor, one-dimensional Gaussian filtering on an N-dimensional data set input into the calculation module.

### CROSS-REFERENCE TO RELATED APPLICATIONS

This application is a national stage of International Application No. PCT/CN2024/100871, filed on Jun. 24, 2024, which claims priority to Chinese Patent Application No. 202311150821.9, filed on Sep. 7, 2023. Both of the aforementioned applications are hereby incorporated by reference in their entireties.

### TECHNICAL FIELD

The present disclosure generally relates to an implementation of Gaussian filtering, and specifically, to a filter, a filtering method, a data processing system, and a chip for Gaussian filtering.

### BACKGROUND

Gaussian filtering is a type of linear smooth filtering and is applicable to eliminating Gaussian noise. For example, most image noises are Gaussian noises. Therefore, Gaussian filtering is widely applied to a noise reduction process of image processing.

In a design process of a filter chip, performance, power, and area (PPA for short) are three indicators that designers pay close attention to. Therefore, there is a wide range of application requirements for improving the PPA of the filter chip.

### SUMMARY

According to an aspect of the present disclosure, there is provided a filter for performing N-dimensional Gaussian filtering on an N-dimensional data set, wherein N is 2 or 3, the filter comprising: a calculation factor obtaining module configured to obtain N calculation factors for N dimensions, wherein the N calculation factors correspond to N one-dimensional Gaussian kernels derived from performing N-dimensional vector decomposition on an N-dimensional Gaussian kernel to be used for the N-dimensional data set; and a calculation module comprising N calculation sub-modules for the N dimensions, the N calculation sub-modules being arranged in a cascading manner, wherein each calculation sub-module is configured to perform, in a respective dimension using a respective calculation factor, one-dimensional Gaussian filtering on an N-dimensional data set input into the calculation module.

According to another aspect of the present disclosure, there is provided a data processing system, comprising: the filter as described above; and a control apparatus configured to provide the N calculation factors to the filter.

According to another aspect of the present disclosure, there is provided a chip. The chip comprises the filter or the data processing system as described above.

According to yet another aspect of the present disclosure, there is provided a filtering method for performing N-dimensional Gaussian filtering on an N-dimensional data set, wherein N is 2 or 3, the filtering method comprising: obtaining N calculation factors for N dimensions, wherein the N calculation factors correspond to N one-dimensional Gaussian kernels derived from performing N-dimensional vector decomposition on an N-dimensional Gaussian kernel to be used for the N-dimensional data set; and sequentially performing one-dimensional Gaussian filtering on the input N-dimensional data set in the N dimensions using the respective calculation factors.

Other features of the present disclosure and advantages thereof will become more apparent from the following detailed description of exemplary embodiments thereof with reference to the accompanying drawings.

### BRIEF DESCRIPTION OF THE DRAWINGS

The accompanying drawings that constitute a part of the specification describe embodiments of the present disclosure and are used to explain the principle of the present disclosure together with the specification.

The present disclosure can be understood more clearly from the following detailed descriptions with reference to the accompanying drawings, wherein:

FIG. 1A is a schematic block diagram showing a configuration of a three-dimensional Gaussian filter according to the related art.

FIG. 1B is a schematic diagram showing a specific example of performing three-dimensional Gaussian filtering using a three-dimensional Gaussian kernel according to the related art.

FIG. 2 is a schematic diagram showing an example of a system architecture of a filter and a data processing system including the filter according to embodiments of the present disclosure.

FIG. 3 is a schematic diagram showing an example of three-dimensional vector decomposition of a three-dimensional Gaussian kernel according to embodiments of the present disclosure.

FIG. 4 is a schematic block diagram showing an example of a configuration of a calculation module according to embodiments of the present disclosure.

FIG. 5 is a schematic diagram showing an example of segmenting a three-dimensional data set according to embodiments of the present disclosure.

FIG. 6 is a flowchart showing an example of data segmentation control using a number of segments according to embodiments of the present disclosure.

FIG. 7A to FIG. 7C are schematic diagrams showing an example of performing Gaussian filtering on a segmented three-dimensional data set in three dimensions sequentially according to embodiments of the present disclosure.

FIG. 8 is a flowchart showing an example of steps of a filtering method according to embodiments of the present disclosure.

It is to be noted that in the embodiments illustrated below, sometimes the same reference signs are jointly used across different accompanying drawings to represent the same parts or parts with the same function, and repeated descriptions thereof are omitted. In some cases, similar numbers and letters are used to represent similar items. Therefore, once a certain item is defined in an accompanying drawing, it does not need to be further discussed in subsequent accompanying drawings.

For ease of understanding, locations, sizes, scopes, and the like of structures shown in the accompanying drawings or the like sometimes do not represent practical locations, sizes, scopes, and the like. Therefore, the present disclosure is not limited to the locations, the sizes, the scopes, and the like disclosed in the accompanying drawings or the like.

### DETAILED DESCRIPTION

The inventors of this application recognized that the conventional Gaussian filter still has much room for improvement in terms of PPA.

Particularly, a Gaussian kernel of the same dimensions is generally used in Gaussian filtering processing of a two-dimensional or three-dimensional data set to perform sliding window calculation on the data set, so that a data value at each point is derived from weighted averaging of its own value and data values of adjacent points in respective dimensions. However, in this solution, a large volume of data needs to be cached, meanwhile a large number of multiplier units and adder units need to be provided. In chip design, this needs to occupy large chip area, which generates high power consumption and is extremely unfriendly to PPA.

In the following description, a case in which three-dimensional Gaussian filtering is to be performed using an S×P×Q three-dimensional Gaussian kernel on a U×V×W three-dimensional data set is taken as an example for analysis. Wherein, S, P, and Q represent numbers of factors of the three-dimensional Gaussian kernel in the respective dimensions, and are all positive odd numbers; U, V, and W represent volumes of data of the three-dimensional data set in the respective dimensions, and are all positive integers; and S U, P V, and Q W. However, a person skilled in the art easily understands that this application is not limited thereto. For example, the following analysis is also applicable to a case in which two-dimensional Gaussian filtering is to be performed using a two-dimensional Gaussian kernel on a two-dimensional data set.

For ease of exemplification, an XYZ coordinate system is used herein to exemplarily represent three respective dimensions. That is, the X direction, the Y direction, and the Z direction may correspond to three respective dimensional directions, respectively. In addition, to conveniently represent each piece of data in the data set, in some examples, the XYZ coordinate system may be appropriately set, so that each piece of data may be indicated by an integer coordinate point position. A person skilled in the art easily understands that this application is not limited thereto.

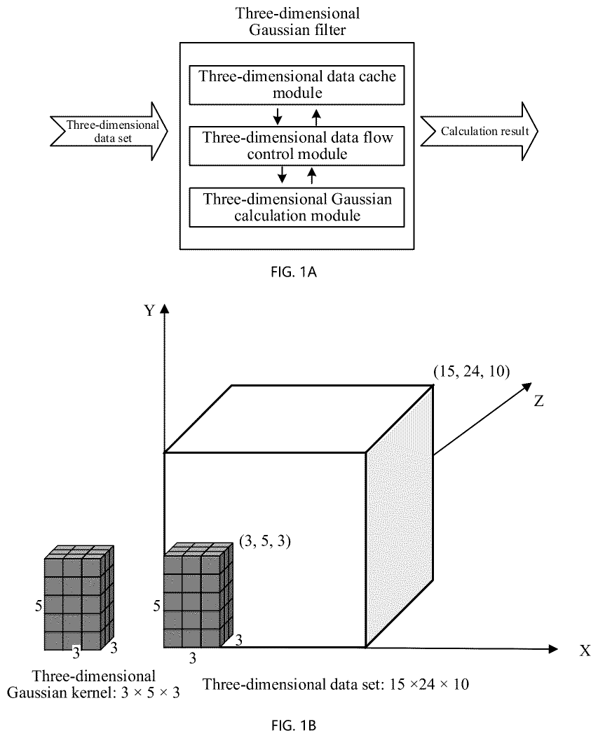

FIG. 1A shows a schematic block diagram of a configuration of a three-dimensional Gaussian filter according to the related art. FIG. 1B shows a schematic diagram of a specific example of performing three-dimensional Gaussian filtering using a three-dimensional Gaussian kernel according to the related art.

As shown in FIG. 1A, the three-dimensional Gaussian filter according to the related art may be configured to receive a three-dimensional data set, perform three-dimensional Gaussian filtering on the received three-dimensional data set, and output a calculation result (that is, a filtered three-dimensional data set).

The three-dimensional Gaussian filter according to the related art may include a three-dimensional data cache module, a three-dimensional data flow control module, and a three-dimensional Gaussian calculation module. Where, the three-dimensional data cache module is configured for caching data that needs to be used in three-dimensional Gaussian calculation, the three-dimensional data flow control module is configured for controlling data reading and writing in the three-dimensional Gaussian filter, and the three-dimensional Gaussian calculation module is configured for performing three-dimensional Gaussian calculation using a three-dimensional Gaussian kernel on data read from the three-dimensional data cache module.

As shown in FIG. 1A, data of the input three-dimensional data set is sent to the three-dimensional data cache module through the three-dimensional data flow control module. The three-dimensional data flow control module counts a volume of data in the three-dimensional data cache module. When the cached data is sufficient for performing three-dimensional Gaussian calculation once with the three-dimensional Gaussian kernel, the cached data is read out and sent to the three-dimensional Gaussian calculation module. After the calculation ends, the three-dimensional Gaussian calculation module returns the calculation result to the three-dimensional data flow control module. The three-dimensional data flow control module outputs the calculation result after receiving it.

It is worth noting that reading and writing of a two-dimensional or three-dimensional data set is generally performed sequentially according to dimensions. As an example, when the three-dimensional data set is cached, only after data of one plane formed by two dimensions has been completely cached can sliding along a third dimension be performed so as to start caching data of next one plane formed by the aforementioned two dimensions. For example, the three-dimensional data set may be cached sequentially according to the order of X, Y, and Z directions, where it is required to completely cache data of one XY plane before sliding along the Z direction so as to start caching data of next one XY plane.

Therefore, the inventors of this application recognized that, in three-dimensional Gaussian filtering in the related art, in each Gaussian calculation performed using a three-dimensional Gaussian kernel on a three-dimensional data set, it needs to use data in all three dimensions. Therefore, a large volume of data in a plurality of complete planes needs to be cached. Since the three-dimensional data set may have a large volume of data in each dimension, a volume of data in a complete plane is very substantial, and the volume of data in the plurality of complete planes that needs to be cached is even more substantial.

Specifically, in the above-described case where S, P, and Q represent the numbers of factors of the three-dimensional Gaussian kernel in the X, Y, and Z directions, respectively, when the last sliding window direction (that is, a direction of caching) is the X direction, at least data in (S−1) YZ planes needs to be cached; alternatively, when the last sliding window direction is the Y direction, at least data in (P−1) XZ planes needs to be cached; or alternatively, when the last sliding window direction is the Z direction, at least data in (Q−1) XY planes needs to be cached.

In addition, the inventors of this application recognized that, in three-dimensional Gaussian filtering in the related art, in each Gaussian calculation performed using a three-dimensional Gaussian kernel on a three-dimensional data set, it needs to use all factors in the three-dimensional Gaussian kernel to be multiplied by respective pieces of data in the data set, respectively, and then sum up the products, which thus requires to use a large number of multiplier units and adder units.

Specifically, in the above-described case where S, P, and Q represent the numbers of factors of the three-dimensional Gaussian kernel in the X, Y, and Z directions, respectively, in each Gaussian calculation, S×P×Q factors in the three-dimensional Gaussian kernel are used to be multiplied by S×P×Q pieces of data in the data set, and then products are summed up. That is, S×P×Q multiplier units and (S×P×Q−1) adder units need to be provided.

For example, in the specific example shown in FIG. 1B, the three-dimensional Gaussian kernel includes 3×5×3 factors, and a three-dimensional data set to be processed includes 15×24×10 pieces of data. Therefore, if the 45 factors in the three-dimensional Gaussian kernel may be represented as kernel[0], kernel[1], . . . , and kernel[44], then a Gaussian filtering result data_guass at any point in the three-dimensional data set may be represented as follows:

$$data\_guass = ( kernel [ 0 ] \times data [ 0 ] + kernel [ 1 ] \times data [ 1 ] + … + kernel [ 44 ] \times data [ 44 ] / ( kernel [ 0 ] + kernel [ 1 ] + … + kernel [ 44 ] ) ,$$

where data[0], data[1], . . . and data[44] represent values of data at corresponding points in the three-dimensional data set.

That is, in calculation for each point, the 3×5×3 factors in the three-dimensional Gaussian kernel need to be multiplied by 3×5×3 pieces of data in the data set, respectively, and then products are summed up. Therefore, 45 multiplier units and 44 adder units need to be provided.

Herein, the division operation may be implemented by truncating low-bit data, and is not considered.

In addition, when the last sliding window direction is the X direction, at least data in two YZ planes needs to be cached, that is, 24×10×2=480 pieces of data need to be cached; alternatively, when the last sliding window direction is the Y direction, at least data in four XZ planes needs to be cached, that is, 15×10×4=600 pieces of data need to be cached; or alternatively, when the last sliding window direction is the Z direction, at least data in two XY planes needs to be cached, that is, 15×24×2=720 pieces of data need to be cached.

Therefore, the inventors of this application recognized that conventional Gaussian filtering needs to occupy large chip area, which generates high power consumption and is extremely unfriendly to PPA. It is desired to provide improved Gaussian filtering, which can have improved PPA.

Various exemplary embodiments of the present disclosure are described below in detail with reference to the accompanying drawings. It should be noted that: unless otherwise specifically illustrated, the relative arrangement of components and steps, numerical expressions, and numerical values set forth in these embodiments do not limit the scope of the present disclosure.

Actually, the following descriptions of at least one exemplary embodiment are merely illustrative, and in no way constitute any limitation on the present disclosure and the application or use thereof. In other words, the structure and the method herein are shown in an exemplary manner to illustrate different embodiments of the structure and the method in the present disclosure. However, one skilled in the art will understand that they merely illustrate exemplary, rather than exhaustive manner in which the present disclosure may be implemented. Moreover, the accompanying drawings are not necessarily drawn to scale, and some features may be exaggerated to show the details of specific components.

Technologies, methods, and devices known to a person of ordinary skill in the art may not be discussed in detail, but in proper circumstances, the technologies, methods, and devices shall be regarded as a part of the granted specification.

In all examples that are shown and discussed herein, any specific value should be interpreted only as an example and not as a limitation. Therefore, other examples of the exemplary embodiments may have different values.

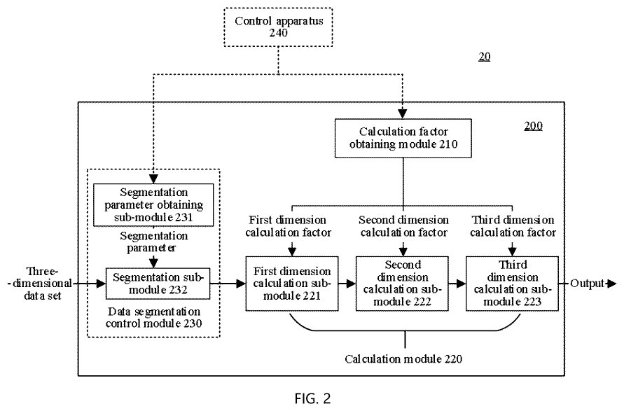

FIG. 2 shows a schematic diagram of an example of a system architecture of a filter 200 and a data processing system 20 including the filter 200 according to embodiments of the present disclosure. In some embodiments, the filter 200 may refer to a filter circuit in a chip.

In the embodiments of the present disclosure, the filter 200 is configured to perform N-dimensional Gaussian filtering on an N-dimensional data set, where N is 2 or 3. As explained above, a case in which three-dimensional Gaussian filtering (N is 3) is performed on a three-dimensional data set is mainly taken as an example for description herein, but these descriptions are also similarly applicable to a case where N is 2.

In the embodiments, the filter 200 may include a calculation factor obtaining module 210 and a calculation module 220. For example, in some embodiments, the calculation factor obtaining module 210 may be a control port of the filter 200 (such as a filter circuit in a chip), and the calculation module 220 is a main circuit part of the filter 200.

In the embodiments, the calculation module 220 may include N calculation sub-modules for N dimensions.

For example, in the case where N=3, in some embodiments, as shown in FIG. 2, three calculation sub-modules for three dimensions may include a calculation sub-module for a first dimension (also referred to as a first dimension calculation sub-module) 221, a calculation sub-module for a second dimension (also referred to as a second dimension calculation sub-module) 222, and a calculation sub-module for a third dimension (also referred to as a third dimension calculation sub-module) 223.

As described above, the X direction, the Y direction, and the Z direction may correspond to three respective dimensional directions, respectively. Herein, a case in which the X direction, the Y direction, and the Z direction correspond to directions of the first dimension, the second dimension, and the third dimension, respectively, is taken as an example for description. However, this correspondence is merely an example. Practically, the first dimension, the second dimension, and the third dimension may correspond to the X direction, the Y direction, and the Z direction in any order.

In the embodiments, the calculation factor obtaining module 210 may be configured to obtain N calculation factors for the N dimensions. Where, the N calculation factors may correspond to N one-dimensional Gaussian kernels derived from performing N-dimensional vector decomposition on an N-dimensional Gaussian kernel to be used for the N-dimensional data set described above.

For example, in the case where N=3, in some embodiments, as shown in FIG. 2, the calculation factor obtaining module 210 may be configured to obtain three calculation factors for the three dimensions, including a calculation factor for the first dimension (also referred to as a first dimension calculation factor) F1, a calculation factor for the second dimension (also referred to as a second dimension calculation factor) F2, and a calculation factor for the third dimension (also referred to as a third dimension calculation factor) F3. These three calculation factors F1, F2, and F3 correspond to three one-dimensional Gaussian kernels K1, K2, and K3 derived from performing three-dimensional vector decomposition on a three-dimensional Gaussian kernel to be used for the three-dimensional data set.

Specifically, through three-dimensional vector decomposition, the S×P×Q three-dimensional Gaussian kernel to be used for the three-dimensional data set as described above may be decomposed into a S×1 one-dimensional Gaussian kernel K1, a P×1 one-dimensional Gaussian kernel K2, and a Q×1 one-dimensional Gaussian kernel K3. Based on this, the calculation factor obtaining module 210 may obtain a S×1 first dimension calculation factor F1, a P×1 second dimension calculation factor F2, and a Q×1 third dimension calculation factor F3 that correspond to K1, K2, and K3, respectively.

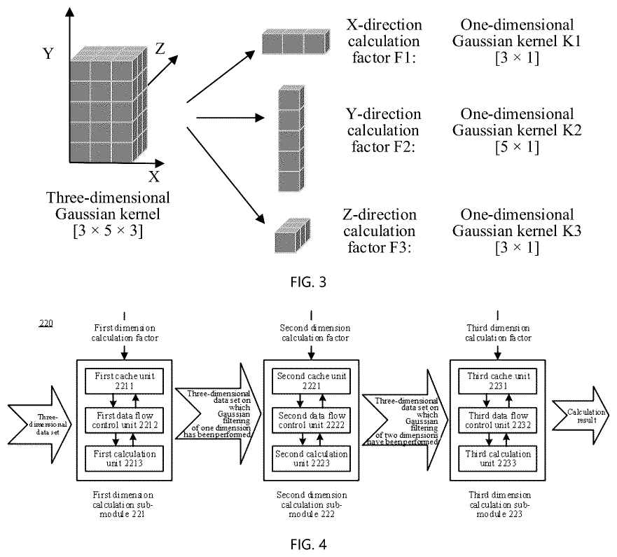

FIG. 3 shows a schematic diagram of an example of three-dimensional vector decomposition of a three-dimensional Gaussian kernel according to embodiments of the present disclosure.

As shown in FIG. 3, through three-dimensional vector decomposition, a 3×5×3 three-dimensional Gaussian kernel may be decomposed into a 3×1 one-dimensional Gaussian kernel K1, a 5×1 one-dimensional Gaussian kernel K2, and a 3×1 one-dimensional Gaussian kernel K3.

In some embodiments, as shown in FIG. 3, three calculation factors F1, F2, and F3 may be equal to the three one-dimensional Gaussian kernels K1, K2, and K3, respectively. Alternatively, in some embodiments, the three calculation factors may correspond to the three one-dimensional Gaussian kernels K1, K2, and K3 through specific relationships, respectively, so as to strengthen or weaken processing effects in certain aspects based on Gaussian filtering. In the following, for ease of description, a case where the three calculation factors F1, F2, and F3 are equal to the three one-dimensional Gaussian kernels K1, K2, and K3, respectively, is taken as an example for description.

In some embodiments, as shown in FIG. 2, the calculation factor obtaining module 210 may be configured to obtain a calculation factor from a control apparatus 240 external to the filter. In some embodiments, the control apparatus 240 may be, for example, a central processing unit or other external controller.

In some embodiments, the data processing system 20 including the filter 200 and the control apparatus 240 constitutes another aspect of the present disclosure.

In some embodiments, the control apparatus 240 may be configured to provide the foregoing N calculation factors to the filter 200. For example, in some embodiments, the control apparatus 240 may generate, according to a received instruction, a three-dimensional Gaussian kernel to be used for the three-dimensional data set, and obtain three respective one-dimensional Gaussian kernels K1, K2, and K3 by performing three-dimensional vector decomposition, and thus obtain the calculation factors F1, F2, and F3. Alternatively, in some embodiments, the control apparatus may directly receive a three-dimensional Gaussian kernel to be used for the three-dimensional data set, and obtain three respective one-dimensional Gaussian kernels K1, K2, and K3 by performing three-dimensional vector decomposition, and thus obtain the calculation factors F1, F2, and F3. Alternatively, in some embodiments, the control apparatus may directly determine, by means of lookup or the like, three one-dimensional Gaussian kernels K1, K2, and K3 corresponding to a three-dimensional Gaussian kernel to be used for the three-dimensional data set, without performing three-dimensional vector decomposition. For example, the control apparatus may pre-store a plurality of commonly used one-dimensional Gaussian kernels, for example, a 3×1 one-dimensional Gaussian kernels of [1:2:1], a 5×1 one-dimensional Gaussian kernel of [1:4:6:4:1] and the like, and directly look up and determine according to the three-dimensional Gaussian kernel to be used for the three-dimensional data set. A person skilled in the art readily understands that this application does not limit a specific process of providing a calculation factor (one-dimensional Gaussian kernel).

In some embodiments, the N-dimensional Gaussian kernel to be used for the N-dimensional data set is a conventional N-dimensional Gaussian kernel. Alternatively, in some embodiments, the N-dimensional Gaussian kernel to be used for the N-dimensional data set is a non-conventional N-dimensional Gaussian kernel. Herein, the conventional Gaussian kernel may refer to a general-purpose Gaussian kernel widely used by a person skilled in the art, and the non-conventional N-dimensional Gaussian kernel may refer to a customized Gaussian kernel different from the general-purpose Gaussian kernel, for example, a customized 3×1 one-dimensional Gaussian kernel [1:6:1]. A person skilled in the art readily understands that this application does not specifically limit this.

Via the calculation factor obtaining module 210, the control apparatus 240 may configure the N calculation factors into the N calculation sub-modules in the calculation module 220, respectively.

In the embodiments, the N calculation sub-modules may be arranged in a cascading manner, and each calculation sub-module may be configured to perform one-dimensional Gaussian filtering in a respective dimension using a respective calculation factor on an N-dimensional data set input into the calculation module.

For example, in the case where N=3, in some embodiments, as shown in FIG. 2, a first dimension calculation sub-module 221, a second dimension calculation sub-module 222, and a third dimension calculation sub-module 223 may be arranged in a cascading manner.

The first dimension calculation sub-module 221 arranged at a first stage may be configured to perform one-dimensional Gaussian filtering in a first dimension using a first dimension calculation factor F1 (corresponding to a S×1 one-dimensional Gaussian kernel K1) through sliding window calculation on a three-dimensional data set input into the calculation module, and transfer the processing result to the second dimension calculation sub-module 222.

Next, the second dimension calculation sub-module 222 arranged at a second stage may be configured to perform one-dimensional Gaussian filtering in a second dimension using a second dimension calculation factor F2 (corresponding to a P×1 one-dimensional Gaussian kernel K2) through sliding window calculation on a three-dimensional data set output by the first dimension calculation sub-module 221, and transfer the processing result to the third dimension calculation sub-module 223.

Finally, the third dimension calculation sub-module 223 arranged at a third stage may be configured to perform one-dimensional Gaussian filtering in a third dimension using a third dimension calculation factor F3 (corresponding to a Q×1 one-dimensional Gaussian kernel K3) through sliding window calculation on a three-dimensional data set output by the second dimension calculation sub-module 222.

It is worth noting that one-dimensional Gaussian filtering may be performed in the three dimensions using the respective calculation factors in any order.

Advantageously, since only one-dimensional Gaussian filtering needs to be performed in each calculation sub-module, numbers of multipliers and adders that need to be used are greatly reduced.

Specifically, in the above-described case where S, P, and Q represent the numbers of factors of the three-dimensional Gaussian kernel in the three dimensions, respectively, in each Gaussian calculation of the first dimension calculation sub-module 221, S×1 factors in the first dimension calculation factor F1 are used to be multiplied by S×1 pieces of data in the data set, respectively, and then products are summed up. That is, S multiplier units and (S−1) adder units need to be provided in the first dimension calculation sub-module 221. Similarly, P multiplier units and (P−1) adder units need to be provided in the second dimension calculation sub-module 222; Q multiplier units and (Q−1) adder units need to be provided in the third dimension calculation sub-module 223. Therefore, the total number of multiplier units required is only S+P+Q, and the total number of adder units is only S+P+Q−3, both of which are much less than the numbers of multiplier units and adder units required in the related art.

FIG. 4 shows a schematic block diagram of an example of a configuration of the calculation module 220 according to embodiments of the present disclosure.

In some embodiments, as shown in FIG. 4, each calculation sub-module in the calculation module 220 includes a cache unit, a data flow control unit, and a calculation unit. Where, the cache unit is configured to cache data required for performing respective one-dimensional Gaussian filtering, the data flow control unit is configured to control data reading and writing in the respective calculation sub-module, and the calculation unit is configured to perform one-dimensional Gaussian filtering using a respective calculation factor on the read data.

Specifically, the first dimension calculation sub-module 221 includes a first cache unit 2211, a first data flow control unit 2212, and a first calculation unit 2213.

The three-dimensional data set input into the calculation module 220 firstly enters the first dimension calculation sub-module 221. The first data flow control unit 2212 writes the input data into the first cache unit 2211 and counts a volume of data in the first cache unit 2211. When the cached data is sufficient for performing one-dimensional Gaussian calculation once in the first dimension using the first dimension calculation factor F1, the cached data is read out and sent to the first calculation unit 2213. The first calculation unit 2213 performs one-dimensional Gaussian calculation using the first dimension calculation factor F1. After the calculation ends, the first calculation unit 2213 returns the calculation result to the first data flow control unit 2212. After receiving the calculation result, the first data flow control unit 2212 outputs the calculation result to the second dimension calculation sub-module 222. Herein, the calculation result output by the first dimension calculation sub-module 221 is a three-dimensional data set on which Gaussian filtering in the first dimension has been performed.

It is worth noting that only (S−1) pieces of data in the first dimension need to be cached for performing one-dimensional Gaussian calculation in the first dimension using a S×1 one-dimensional Gaussian kernel. As described above, reading and writing of the three-dimensional data set is generally performed sequentially according to dimensions. During writing of the three-dimensional data set into the first cache unit 2211, if the first dimension is set as a first one dimension for reading and writing, then the first cache unit 2211 needs to cache only (S−1) pieces of data, which is sufficient for performing one-dimensional Gaussian calculation once in the first dimension using the first dimension calculation factor F1 (corresponding to the S×1 one-dimensional Gaussian kernel K1).

Therefore, a requirement for cache capacity of the first cache unit 2211 of the first dimension calculation sub-module 221 arranged at the first stage is (S−1) pieces of data.

The second dimension calculation sub-module 222 includes a second cache unit 2221, a second data flow control unit 2222, and a second calculation unit 2223.

The second dimension calculation sub-module 222 receives the three-dimensional data set on which Gaussian filtering of one dimension has been performed from the first dimension calculation sub-module 221. The second data flow control unit 2222 writes the input data into the second cache unit 2221 and counts a volume of data in the second cache unit 2221. When the cached data is sufficient for performing one-dimensional Gaussian calculation once in the second dimension using the second dimension calculation factor F2, the cached data is read out and sent to the second calculation unit 2223. The second calculation unit 2223 performs one-dimensional Gaussian calculation using the second dimension calculation factor F2. After the calculation ends, the second calculation unit 2223 returns the calculation result to the second data flow control unit 2222. After receiving the calculation result, the second data flow control unit 2222 outputs the calculation result to the third dimension calculation sub-module 223. Herein, the calculation result output by the second dimension calculation sub-module 222 is a three-dimensional data set on which Gaussian filtering in the first dimension and Gaussian filtering in the second dimension have been performed.

Similar to the foregoing analysis, only (P−1) pieces of data in the second dimension need to be cached for performing one-dimensional Gaussian calculation in the second dimension using a P×1 one-dimensional Gaussian kernel. However, it is worth noting that since the data set written into the second cache unit 2221 is from the first dimension calculation sub-module 221, and the first dimension calculation sub-module 221 first performs reading and writing along the first dimension, and performs sliding window calculation along the first dimension, the (P−1) pieces of data that need to be cached for performing one-dimensional Gaussian calculation in the second dimension as described above cannot be successively written into the second cache unit 2221. If the second dimension is set as a second one dimension for reading and writing, then the second cache unit 2221 needs to cache (P−1) rows of pieces of data to be sufficient to perform one-dimensional Gaussian calculation once in the second dimension using the second dimension calculation factor F2 (corresponding to the P×1 one-dimensional Gaussian kernel K2). One row of pieces of data herein refers to a volume of data of the input three-dimensional data set in the first dimension. In a case where the U×V×W three-dimensional data set as described above is used, the second cache unit 2221 needs to cache (P−1)×U pieces of data.

Therefore, a requirement for cache capacity of the second cache unit 2221 of the second dimension calculation sub-module 222 arranged at the second stage is (P−1) rows of pieces of data, where a volume of data of one row is a volume of data of the three-dimensional data set input into the calculation module 220 in the first dimension.

The third dimension calculation sub-module 223 includes a third cache unit 2231, a third data flow control unit 2232, and a third calculation unit 2233.

The third dimension calculation sub-module 223 receives the three-dimensional data set on which Gaussian filtering of two dimensions has been performed from the second dimension calculation sub-module 222. The third data flow control unit 2232 writes the input data set into the third cache unit 2231 and counts a volume of data in the third cache unit 2231. When the cached data is sufficient for performing one-dimensional Gaussian calculation once in the third dimension using the third dimension calculation factor F3, the cached data is read out and sent to the third calculation unit 2233. The third calculation unit 2233 performs one-dimensional Gaussian calculation using the third dimension calculation factor F3. After the calculation ends, the third calculation unit 2233 returns the calculation result to the third data flow control unit 2232. The third data flow control unit 2232 outputs the calculation result after receiving it.

Similar to the foregoing analysis, only (Q−1) pieces of data in the third dimension need to be cached for performing one-dimensional Gaussian calculation in the third dimension using a Q×1 one-dimensional Gaussian kernel, however, the (Q−1) pieces of data in the third dimension cannot be successively written into the third cache unit 2231. Since the third dimension is set as the last one dimension for reading and writing and sliding window calculation, the third cache unit 2231 needs to cache (Q−1) planes of pieces of data to be sufficient to perform one-dimensional Gaussian calculation once in the third dimension using the third dimension calculation factor F3 (corresponding to the Q×1 one-dimensional Gaussian kernel K3). One plane of pieces of data herein refers to a volume of data of the input three-dimensional data set in a plane formed by the first dimension and the second dimension. In a case where the U×V×W three-dimensional data set described above is used, the third cache unit 2231 needs to cache (Q−1)×U×V pieces of data.

Therefore, a requirement for cache capacity of the third cache unit 2231 of the third dimension calculation sub-module 222 arranged at the third stage is (Q−1) planes of pieces of data, where a volume of data of one plane is a volume of data of the three-dimensional data set input into the calculation module 220 in a plane formed by the first dimension and the second dimension.

The inventors of this application recognized that the data volume of the N-dimensional data set input into the filter 200 in each dimension may be large. Therefore, if the N-dimensional data set input into the filter 200 is directly input into the calculation module 220, then the data volume of a row or plane that needs to be cached is substantial. To solve the problem described above, this application proposes that the N-dimensional data set is segmented into several small segments before the N-dimensional data set is input into the calculation module 220, so as to reduce caching resources. Generally, the greater the number of segments is, the smaller the cache resources are required, which thereby can greatly save chip area.

Therefore, in some embodiments, the filter 200 may further include a data segmentation control module 230. The data segmentation control module 230 may be configured to segment, in any one or more of the N dimensions, the N-dimensional data set input into the filter 200 and input the segmented N-dimensional data set into the calculation module 220. Therefore, the data volume of the N-dimensional data set input into the calculation module in one or more dimensions can be advantageously reduced. In some embodiments, the data segmentation control module 230 may be refer to a data segmentation circuit in a chip.

For example, in the case where N=3, in some embodiments, as shown in FIG. 2, the data segmentation control module 230 is configured to segment the three-dimensional data set input into the filter 200 and input the segmented three-dimensional data set into the calculation module 220.

Although FIG. 2 exemplifies a case where the filter 200 includes the data segmentation control module 230, this application is not limited thereto. For example, alternatively, in some embodiments, the data segmentation control module 230 may be arranged separately from the filter 200. For example, the data segmentation control module 230 may be provided at a separate position on the same chip as the filter 200. Or alternatively, in some embodiments, the data segmentation control module 230 may be provided on a different chip from the filter 200.

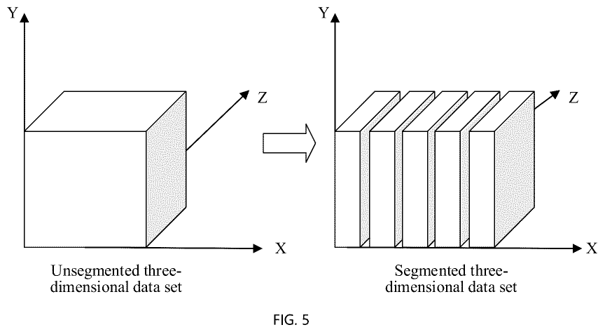

FIG. 5 shows a schematic diagram of an example of segmenting a three-dimensional data set according to embodiments of the present disclosure.

In the example shown in FIG. 5, the three-dimensional data set is segmented in the X direction. As can be observed, such segmentation of the three-dimensional data set in one dimension may be vividly understood as “slicing” the three-dimensional data set in this dimension. For example, five 3×24×10 three-dimensional data sets can be obtained through evenly segmenting one input 15×24×10 three-dimensional data set into five segments. In this way, in a case where data of a plurality of XY planes or XZ planes needs to be cached, the data volume that needs to be cached can be reduced to ⅕ of the original volume, thereby greatly saving chip area.

Although FIG. 5 exemplifies the case where the three-dimensional data set is segmented in the X direction, this is merely an example. In fact, in some embodiments, the data segmentation control module 230 may segment the input three-dimensional data set in any one, two, or three dimensions. For example, the direction of segmentation may include any one or more of the X direction, the Y direction, and the Z direction shown in FIG. 5.

Although an example of evenly segmenting the three-dimensional data set is described above with reference to FIG. 5, this is merely an example, and this application is not limited thereto. For example, in actual operations, if even segmentation cannot be accurately performed, even segmentation may be approximately performed, or only one or a few of the segmented data sets may be different from the others. In addition, in general, each three-dimensional data set obtained from segmentation should be not smaller than a three-dimensional Gaussian kernel to be used for performing three-dimensional Gaussian filtering thereon.

In some embodiments, the data segmentation control module 230 may include a segmentation parameter obtaining sub-module 231 and a segmentation sub-module 232. Wherein, the segmentation parameter obtaining sub-module 231 may be configured to obtain a segmentation parameter, and the segmentation sub-module 232 may be configured to segment, according to the segmentation parameter, the N-dimensional data set input into the filter 200. For example, in some embodiments, the segmentation parameter obtaining sub-module 231 may be a control port of the data segmentation control module 230 (such as a data segmentation circuit in a chip), and the segmentation sub-module 232 may be a main circuit part of the data segmentation control module 230.

In some embodiments, as shown in FIG. 2, the segmentation parameter obtaining sub-module 231 may be configured to obtain the segmentation parameter from a control apparatus 240 external to the filter. For example, in some embodiments, the control apparatus 240 may be, for example, a central processing unit or other external controller.

In the example shown in FIG. 2, the segmentation parameter obtaining sub-module 231 and the calculation factor obtaining module 210 may obtain information from the same control apparatus 240, but this application is not limited thereto. For example, the segmentation parameter obtaining sub-module 231 and the calculation factor obtaining module 210 may obtain information from different control apparatuses 240. Alternatively, in some embodiments, the segmentation parameter obtaining sub-module 231 may be configured to directly receive an input of an operator, to obtain a segmentation parameter included in the input information.

In some embodiments, the segmentation parameter may include a direction of segmentation and a size of segment.

In some embodiments, the direction of segmentation may include direction(s) corresponding to any one or more of the N dimensions. For example, the direction of segmentation may include any one or more of the X direction, the Y direction, and the Z direction shown in FIG. 5.

In some embodiments, the size of segment may refer to a size of a three-dimensional data set to be obtained through segmentation. In a case where the three-dimensional data set input into the filter cannot be segmented into an integer number of three-dimensional data sets with the size of segment, even segmentation may be performed first according to the size of segment, and a finally remaining three-dimensional data set with a size smaller than or slightly larger than the size of segment is output as last one three-dimensional data set obtained through segmentation. In addition, in general, the size of segment should be not smaller than a three-dimensional Gaussian kernel to be used for performing three-dimensional Gaussian filtering on the three-dimensional data set. In a case where only “slicing” in a single direction is performed on the data set, in some embodiments, the size of segment may simply indicate a length of segment in the direction of segmentation.

In some embodiments, the segmentation sub-module 232 may perform segmentation through the following steps: repeatedly reading, according to the direction of segmentation and the size of segment, a respective data set from the N-dimensional data set input to the filter 200 and outputting the respective data set, until all data in the N-dimensional data set input to the filter 200 has been read.

For example, in the case shown in FIG. 5, the segmentation sub-module 232 may repeatedly read and output, according to the direction of segmentation being the X direction and the length of segment being 3, a respective 3×24×10 data set from the 15×24×10 three-dimensional data set input into the filter 200, until all data in the 15×24×10 three-dimensional data set input into the filter 200 has been read.

In the step described above, it may be relatively complex to determine whether all the data has been read. To realize the determining described above, in some embodiments, the segmentation parameter obtained by the segmentation parameter obtaining sub-module 231 may further include a number of segments.

Therefore, in some embodiments, the segmentation sub-module 232 may perform segmentation through the following steps: repeatedly reading, according to the direction of segmentation and the size of segment, a respective data set from the N-dimensional data set input into the filter 200, and outputting the respective data set, until a number of the output data sets is equal to the number of segments.

For example, in the case shown in FIG. 5, the segmentation sub-module 232 may repeatedly read and output, according to the direction of segmentation being the X direction and the length of segment being 3, a respective 3×24×10 data set from the 15×24×10 three-dimensional data set input into the filter 200, until a number of the output data sets is equal to the number of segments that is 5.

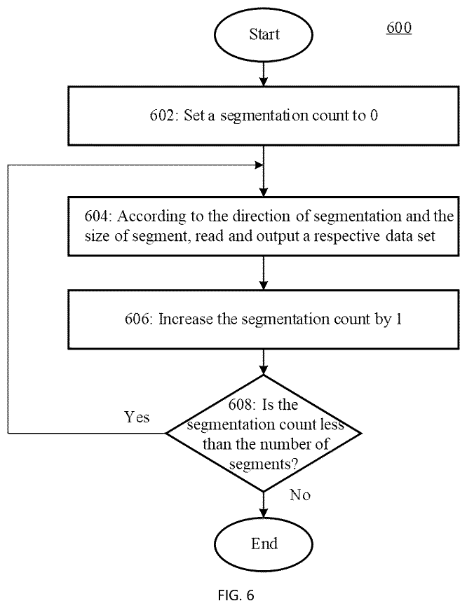

FIG. 6 shows a flowchart of an example of data segmentation control using a number of segments according to embodiments of the present disclosure. In some embodiments, steps of data segmentation control shown in FIG. 6 may be performed by the segmentation sub-module 232.

As shown in FIG. 6, data segmentation control 600 according to the embodiments of the present disclosure may mainly include the following steps.
Step 602: Set a segmentation count to 0.
Step 604: According to a direction of segmentation and a size of segment, read and output a respective data set.
Step 606: Increase the segmentation count by 1.
Step 608: Compare the segmentation count with a number of segments. If the segmentation count is less than the number of segments (the comparison result is “yes”), then the processing goes back to step 604. Otherwise (the comparison result is “no”), end the segmentation processing.

Segmenting an N-dimensional data set before the N-dimensional data set is input into the calculation module 220 can reduce the data volume of the N-dimensional data set input into the calculation module 220 in one or more dimensions, thereby advantageously reducing caching resources.

For example, when the direction of segmentation is the first dimension, and the number of segments is M, the data volume of the three-dimensional data set input into the calculation module 220 in the first dimension is reduced to 1/M. Therefore, according to the foregoing analysis, the requirement for cache capacity of the second cache unit 2221 and the requirement for cache capacity of the third cache unit 2231 are both reduced to 1/M of the original. For example, the requirement for cache capacity of the second cache unit 2221 is reduced to (P−1)×U/M, and the requirement for cache capacity of the third cache unit 2231 is reduced to (P−1)×U×V/M.

If reading and writing are likewise performed in the order of the first dimension, the second dimension, and the third dimension, the requirement for cache capacity of the three-dimensional Gaussian filter in the related art is (P−1)×U×V. The applicants noted that the number of segments is inevitably greater than 1. Therefore, the total amount of caching required by the Gaussian filter according to the embodiments of the present disclosure is much less than that of the Gaussian filter in the related art. In addition, as the number of segments increases, this effect becomes more pronounced.

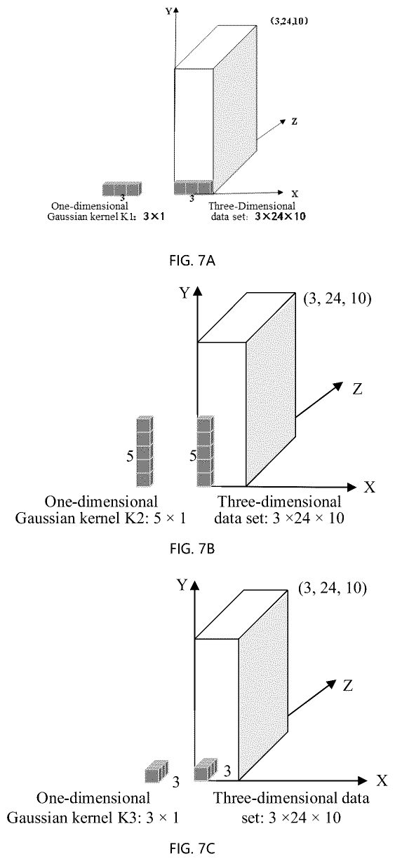

FIG. 7A to FIG. 7C are schematic diagrams showing an example of performing Gaussian filtering on a segmented three-dimensional data set in three dimensions sequentially according to embodiments of the present disclosure. Similar to the case shown in FIG. 1B, three-dimensional Gaussian filtering is to be performed on a 15×24×10 three-dimensional data set using a 3×5×3 three-dimensional Gaussian kernel.

In one aspect, the one input 15×24×10 three-dimensional data set is evenly segmented into five segments in the X direction, obtaining five 3×24×10 three-dimensional data sets. In another aspect, three-dimensional vector decomposition is performed on the 3×5×3 three-dimensional Gaussian kernel, obtaining a 3×1 one-dimensional Gaussian kernel K1 in the X direction, a 5×1 one-dimensional Gaussian kernel K2 in the Y direction, and a 3×1 one-dimensional Gaussian kernel K3 in the Z direction.

According to the foregoing analysis, 3 multipliers and 2 adders are required for one-dimensional Gaussian filtering in the X direction; 5 multipliers and 4 adders are required for one-dimensional Gaussian filtering in the Y direction; and 3 multipliers and 2 adders are required for one-dimensional Gaussian filtering in the Z direction. Therefore, a total of 11 multiplier resources and 8 adder resources are required.

In addition, in a case where reading and writing are performed in the order of the first dimension, the second dimension, and the third dimension, the data volume that needs to be cached in one-dimensional Gaussian calculation in the X direction is: 3−1=2; the data volume that needs to be cached in one-dimensional Gaussian calculation in the Y direction is: (3−1)×15/5=6; and the data volume that needs to be cached in one-dimensional Gaussian calculation in the Z direction is: (3−1)×15×24/5=144. Therefore, total caching resources required are 152 pieces of data.

In contrast, in the related art of performing three-dimensional Gaussian filtering on a 15×24×10 three-dimensional data set directly using a 3×5×3 three-dimensional Gaussian kernel, if reading and writing are likewise performed in the order of the first dimension, the second dimension, and the third dimension, according to the analysis described above, a total of 45 multiplier resources and 44 adder resources are required, and total caching resources required are 720 pieces of data.

Table 1 below gives specific comparisons.

TABLE 1

| | | | Reduction |
|---|---|---|---|
| | Related art | This application | of resources |
| Cache resources | 720 | 152 | 78.9% |
| Multiplier resources | 45 | 11 | 75.5% |
| Adder resources | 44 | 8 | 81.8% |

As shown in Table 1, 78.9% of caching resources, 75.5% of multiplier resources, and 81.8% of adder resources can be saved.

Advantageously, the filter according to the embodiments of the present disclosure can segment the N-dimensional data set into several small segments before performing N-dimensional Gaussian filtering on the N-dimensional data set, to reduce the data caching resource requirement, thereby greatly saving chip area. In addition, the filter according to the embodiments of the present disclosure can perform calculation using N one-dimensional Gaussian kernels after performing dimension reduction processing on an N-dimensional Gaussian kernel, thereby reducing a large number of adders and multipliers, lowering the calculation resource requirement, both saving chip area, and lowering chip power consumption.

In some embodiments, a chip including the filter 200 or the data processing system 20 described above constitutes another aspect of the present disclosure.

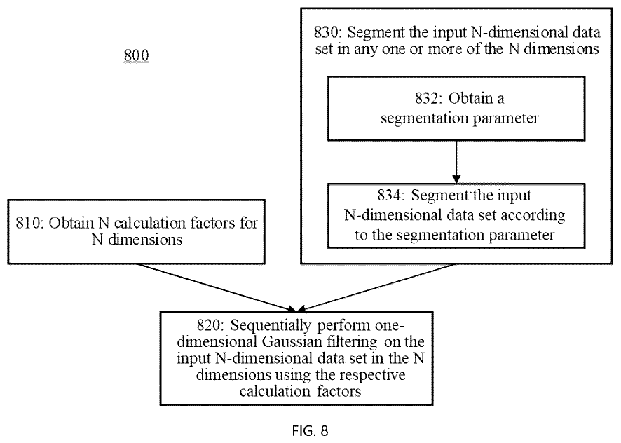

Steps of a filtering method according to embodiments of the present disclosure are exemplarily described below with reference to FIG. 8. The content described above with reference to FIG. 1A to FIG. 1B, FIG. 2 to FIG. 6, and FIG. 7A to FIG. 7C may also be applicable to corresponding features. In some embodiments, the filtering method according to an embodiment of the present disclosure may be performed by a circuit on a chip.

As shown in FIG. 8, according to some embodiments of the present disclosure, a filtering method 800 may be used for performing N-dimensional Gaussian filtering on an N-dimensional data set, where N is 2 or 3. The filtering method 800 mainly includes the following steps.
Step 810: Obtain N calculation factors for N dimensions, where the N calculation factors correspond to N one-dimensional Gaussian kernels derived from performing N-dimensional vector decomposition on an N-dimensional Gaussian kernel to be used for the N-dimensional data set.
Step 820: Sequentially perform one-dimensional Gaussian filtering on the input N-dimensional data set in the N dimensions using the respective calculation factors.

In some embodiments, before step 820, the filtering method 800 may further include step 830: segment the input N-dimensional data set in any one or more of the N dimensions.

In some embodiments, step 830 may mainly include the following sub-steps.
Sub-step 832: Obtain a segmentation parameter.
Sub-step 834: Segment the input N-dimensional data set according to the segmentation parameter.

In some embodiments, the segmentation parameter may include a direction of segmentation and a size of segment.

Therefore, the sub-step 834 may be implemented in the following manner: repeatedly reading a respective data set from the input N-dimensional data set according to the direction of segmentation and the size of segment and outputting the respective data set, until all data in the input N-dimensional data set has been read.

In some embodiments, the segmentation parameter may further include a number of segments.

Therefore, the sub-step 834 may be implemented in the following manner: repeatedly reading a respective data set from the input N-dimensional data set according to the direction of segmentation and the size of segment and outputting the respective data set, until a number of the output data sets is equal to the number of segments.

In some embodiments, the performing one-dimensional Gaussian filtering on the input N-dimensional data set in each dimension using a respective calculation factor in step 820 may include: caching data required for performing respective one-dimensional Gaussian filtering; reading the cached data; and performing one-dimensional Gaussian filtering on the read data using the respective calculation factor.

There are (S−1) pieces of data that need to be cached in firstly performed one-dimensional Gaussian filtering in the first dimension, and there are (P−1) rows of pieces of data that need to be cached in subsequently performed one-dimensional Gaussian filtering in the second dimension, wherein S and P are numbers of factors of the above-described N-dimensional Gaussian kernel in the first dimension and the second dimension, and a volume of data of one row is a volume of data of the input three-dimensional data set in the first dimension.

In the case where N=3, there are (Q−1) planes of pieces of data that need to be cached in finally performed one-dimensional Gaussian filtering in a third dimension, wherein Q is a number of factors of the above-described N-dimensional Gaussian kernel in the third dimension, and a volume of data of one plane is a volume of data of the input three-dimensional data set in a plane formed by the first dimension and the second dimension.

Advantageously, in the filtering method according to the embodiments of the present disclosure, the N-dimensional data set can be segmented into several small segments before N-dimensional Gaussian filtering is performed on the N-dimensional data set, to reduce the data caching resource requirement, thereby greatly saving chip area. In addition, in the filtering method according to the embodiments of the present disclosure, calculation can be performed using N one-dimensional Gaussian kernels after dimension reduction processing on the N-dimensional Gaussian kernel, thereby reducing a large number of adders and multipliers, lowering the calculation resource requirement, both saving chip area, and lowering chip power consumption.

It is worth noting that the boundaries between steps in the method described above are only illustrative. In practice, each step can be arbitrarily combined or even combined into a single step. In addition, the execution order of each step is not limited by the order described, and some steps can be omitted. The operation steps of the various embodiments may also be combined with each other in any suitable order, so as to similarly realize more or less operations than those described.

The terms “front”, “back”, “top”, “bottom”, “over”, “under” and the like in the description and in the claims, if any, are used for descriptive purposes and not necessarily for describing constant relative positions. It is to be understood that the terms thus used are interchangeable under appropriate circumstances such that the embodiments of the disclosure as described herein are, for example, capable of being operated in other orientations different than those as illustrated or otherwise described herein.

As used herein, the word “exemplary” means “serving as an example, instance, or illustration”, instead of serving as a “model” that is to be accurately reproduced. Any implementation illustratively described herein is not necessarily to be construed as preferred or advantageous over other implementations. Furthermore, the present disclosure is not limited by any expressed or implied theory presented in the preceding parts of Technical Field, Background Art, Contents of the Invention or Embodiment.

As used herein, the term “substantially” is intended to encompass any minor variation caused by design or manufacturing imperfections, tolerances of devices or components, environmental influences, and/or other factors. The word “substantially” also allows for differences from a perfect or ideal situation due to parasitics, noise, and other practical considerations that may exist in a practical implementation.

In addition, the foregoing description may mention elements or nodes or features being “connected” or “coupled” together. As used herein, the term “connected” means one element/node/feature is electronically, mechanically, logically or otherwise directly linked (or directly communicates) with another element/node/feature, unless otherwise illustrated. Similarly, unless otherwise illustrated, the term “coupling” means one element/node/feature may be mechanically, electronically, logically or otherwise linked to another element/node/feature in a directly or indirect manner to allow an interaction therebetween, even if these two features may not be linked directly. In other words, the term “coupling” intends to include directly links and indirect links between elements or other features, including connections through one or more intermediate elements.

Additionally, for reference purposes only, similar terms as “first”, “second” and the like may also be used herein, and thus are not intended to be limiting. For example, the terms “first”, “second” and other such numerical terms relating to structures or elements do not imply a sequence or order unless clearly indicated by the context.

It will be further understood that the term “comprising/including”, when used herein, specifies the presence of stated features, integers, steps, operations, units and/or components, but the presence or addition of one or more other features, integers, steps, operations, units and/or components, and/or combinations thereof is not excluded.

In the present disclosure, the term “providing” is used in a broad sense to cover all ways of obtaining an object, and thus “providing an object” includes, but is not limited to, “purchasing”, “preparing/fabricating”, “arranging/setting”, “installing/assembling”, and/or “ordering” an object, etc.

It shall be realized by those skilled in the art that boundaries between said operations are only illustrative. Multiple operations may be combined into a single operation, and a single operation may be distributed in additional operations, and moreover, the operations may be performed in an at least partially overlapping manner in time. Furthermore, optional embodiments may include multiple examples of specific operations, and the operation sequence may be changed in various other embodiments. However, other modifications, changes and replacements are also possible. Thus, the description and drawings shall be deemed as illustrative instead of limitative.

Although some specific embodiments of the present disclosure have been exemplified in detail, it shall be understood by those skilled in the art that the above examples are only illustrative, but shall by no means limit the scope of the present disclosure. The respective examples of the disclosure may be combined in any manner, without departure from spirits and scope of the present disclosure. It shall further be understood by those skilled in the art that multiple amendments may be made to the examples, without departure from the scope and spirits of the present disclosure. The scope of the present disclosure is defined by the attached claims.

1. A filter for performing N-dimensional Gaussian filtering on an N-dimensional data set, wherein N is 2 or 3, the filter comprising:
a calculation factor obtaining module configured to obtain N calculation factors for N dimensions, wherein the N calculation factors correspond to N one-dimensional Gaussian kernels derived from performing N-dimensional vector decomposition on an N-dimensional Gaussian kernel to be used for the N-dimensional data set; and
a calculation module comprising N calculation sub-modules for the N dimensions, the N calculation sub-modules being arranged in a cascading manner, wherein each calculation sub-module is configured to perform, in a respective dimension using a respective calculation factor, one-dimensional Gaussian filtering on an N-dimensional data set input into the calculation module.

2. The filter according to claim 1, wherein the filter further comprises a data segmentation control module configured to segment, in any one or more of the N dimensions, the N-dimensional data set input into the filter and input the segmented N-dimensional data set into the calculation module.

3. The filter according to claim 2, wherein the data segmentation control module comprises:
a segmentation parameter obtaining sub-module configured to obtain a segmentation parameter; and
a segmentation sub-module configured to segment, according to the segmentation parameter, the N-dimensional data set input into the filter.

4. The filter according to claim 3, wherein the segmentation parameter comprise a direction of segmentation and a size of segment.

5. The filter according to claim 4, wherein the segmentation sub-module is configured to:
according to the direction of segmentation and the size of segment, repeatedly read a respective data set from the N-dimensional data set input into the filter and output the respective data set, until all data in the N-dimensional data set input into the filter has been read.

6. The filter according to claim 4, wherein the segmentation parameter further comprise a number of segments.

7. The filter according to claim 6, wherein the segmentation sub-module is configured to:
according to the direction of segmentation and the size of segment, repeatedly read a respective data set from the N-dimensional data set input into the filter and output the respective data set, until a number of the output data sets is equal to the number of segments.

8. The filter according to claim 1, wherein the calculation factor obtaining module is configured to obtain the calculation factors from a control apparatus external to the filter.

9. The filter according to claim 1, wherein each calculation sub-module comprises:
a cache unit configured to cache data required for performing respective one-dimensional Gaussian filtering;
a data flow control unit configured to control data reading and writing in the respective calculation sub-module; and
a calculation unit configured to perform one-dimensional Gaussian filtering on the read data using the respective calculation factor.

10. The filter according to claim 9, wherein in the calculation module, a requirement for cache capacity of a first cache unit of a first dimension calculation sub-module arranged at a first stage is (S−1) pieces of data, and a requirement for cache capacity of a second cache unit of a second dimension calculation sub-module arranged at a second stage is (P−1) rows of pieces of data, wherein S and P are numbers of factors of the N-dimensional Gaussian kernel in a first dimension and a second dimension, and a volume of data of one row is a volume of data of a three-dimensional data set input into the calculation module in the first dimension.

11. The filter according to claim 10, wherein in a case where N=3, in the calculation module, a requirement for cache capacity of a third cache unit of a third dimension calculation sub-module arranged at a third stage is (Q−1) planes of pieces of data, wherein Q is a number of factors of the N-dimensional Gaussian kernel in a third dimension, and a volume of data of one plane is a volume of data of the three-dimensional data set input into the calculation module in a plane formed by the first dimension and the second dimension.

12. A data processing system, comprising:
the filter according to claim 1; and
a control apparatus configured to provide the N calculation factors to the filter.

13. A chip, wherein the chip comprises the filter according to claim 1.

14. A filtering method for performing N-dimensional Gaussian filtering on an N-dimensional data set, wherein N is 2 or 3, the filtering method comprising:
obtaining N calculation factors for N dimensions, wherein the N calculation factors correspond to N one-dimensional Gaussian kernels derived from performing N-dimensional vector decomposition on an N-dimensional Gaussian kernel to be used for the N-dimensional data set; and
sequentially performing one-dimensional Gaussian filtering on the input N-dimensional data set in the N dimensions using the respective calculation factors.

15. The filtering method according to claim 14, further comprising: segmenting the input N-dimensional data set in any one or more of the N dimensions before sequentially performing one-dimensional Gaussian filtering on the input N-dimensional data set in the N dimensions using the respective calculation factors.

16. The filtering method according to claim 15, wherein the segmenting the input N-dimensional data set comprises:
obtaining a segmentation parameter; and
segmenting the input N-dimensional data set according to the segmentation parameter.

17. The filtering method according to claim 16, wherein the segmentation parameter comprise a direction of segmentation and a size of segment.

18. The filtering method according to claim 17, wherein the segmenting the input N-dimensional data set according to the segmentation parameter comprises:
according to the direction of segmentation and the size of segment, repeatedly reading a respective data set from the input N-dimensional data set and outputting the respective data set, until all data in the input N-dimensional data set has been read.

19. The filtering method according to claim 17, wherein the segmentation parameter further comprise a number of segments.

20. The filtering method according to claim 19, wherein the segmenting the input N-dimensional data set according to the segmentation parameter comprises:
according to the direction of segmentation and the size of segment, repeatedly reading a respective data set from the input N-dimensional data set and outputting the respective data set, until a number of the output data sets is equal to the number of segments.

21.-23. (canceled)
